(19) United States
(12) Patent Application Publication
(10) Pub. No.: US 2020/0027652 A1
(43) Pub. Date: Jan. 23, 2020

(54) NOISE FILTER AND POWER CONVERSION APPARATUS

(71) Applicant: Mitsubishi Electric Corporation, Chiyoda-ku, Tokyo (JP)

(72) Inventors: Hirokazu TAKABAYASHI, Chiyoda-ku, Tokyo (JP); Yasuhiro SHIRAKI, Tokyo (JP)

(73) Assignee: Mitsubishi Electric Corporation, Chiyoda-ku, Tokyo (JP)

(21) Appl. No.: 16/496,499

(22) PCT Filed: Mar. 31, 2017
(86) PCT No.: PCT/JP2017/013581

§ 371 Date: Sep. 23, 2019

(51) Int. Cl. H01F 27/33; H01F 27/24; H01F 27/29; H02M 1/44

(52) U.S. Cl. CPC H01F 27/33; H02M 1/44; H01F 27/29; H01F 27/24

(57) ABSTRACT

A noise filter includes a center conductor, at least one outer conductor, and a core. The outer conductor is cylindrical in shape, and the center conductor is inserted through the interior of the outer conductor. The core is a cylindrical magnetic body, and the center conductor and the at least one outer conductor are inserted through the interior of the core. The center conductor and the at least one outer conductor are insulated from each other. Phase currents for each phase of a symmetrical polyphase alternating current flow through the center conductor and the at least one outer conductor.

### TECHNICAL FIELD

The present disclosure relates to a noise filter and a power conversion apparatus that includes the noise filter.

### BACKGROUND ART

An inverter device is provided with an electro-magnetic compatibility (EMC) filter that reduces noise generated by an inverter. In an EMC filter unit disclosed in Patent Literature 1, cables for each phase are wound around a ring core composed of ring-shaped ferrite cores. High-frequency noise current flowing through the cables produces a magnetic field that is concentrated into the ferrite cores, and high frequency loss attenuates noise by converting the magnetic field into heat.

### CITATION LIST

### Patent Literature

Patent Literature 1: Japanese Patent No. 5499795

### SUMMARY OF INVENTION

### Technical Problem

Even if high-frequency noise current does not flow through a conductor, a steady-state current produces a magnetic field around the conductor. In the EMC filter unit disclosed in Patent Literature 1, the ring core concentrates not only a magnetic field produced by high-frequency noise current but also the magnetic field produced by the steady-state current. Consequently, magnetic saturation in the ring core occurs and noise removal efficiency may decrease.

In order to solve the aforementioned circumstances, an objective of the present disclosure is to improve noise removal efficiency.

### Solution to Problem

In order to achieve the aforementioned objective, a noise filter of the present disclosure includes a center conductor, at least one outer conductor, and a core. The at least one outer conductor is cylindrical in shape and has an interior through which the center conductor is inserted. The core is a cylindrical magnetic body and has an interior through which the center conductor and the at least one outer conductor are inserted. The center conductor and the at least one outer conductor are insulated from each other. Phase currents of symmetrical polyphase alternating current flow through the center conductor and the at least one outer conductor.

### Advantageous Effects of Invention

According to the present disclosure, the noise filter is provided with the at least one cylindrical outer conductor that is inserted through the interior of the cylindrical core and the center conductor that is inserted through the interior of the at least one outer conductor, thereby enabling the noise filter to improve noise removal efficiency.

### BRIEF DESCRIPTION OF DRAWINGS

FIG. 1 is a cross-sectional view of a noise filter according to Embodiment 1 of the present disclosure;

FIG. 2 is a cross-sectional view of a conventional noise filter;

FIG. 3 is side view of the noise filter according to Embodiment 1;

FIG. 4 is a block diagram illustrating an example configuration of a power conversion apparatus according to Embodiment 1; and

FIG. 5 is a cross-sectional view of a noise filter according to Embodiment 2 of the present disclosure.

### DESCRIPTION OF EMBODIMENTS

Embodiments of the present disclosure are described below in detail with reference to the drawings. Throughout the drawings, components that are the same or equivalent are assigned the same reference signs.

### Embodiment 1

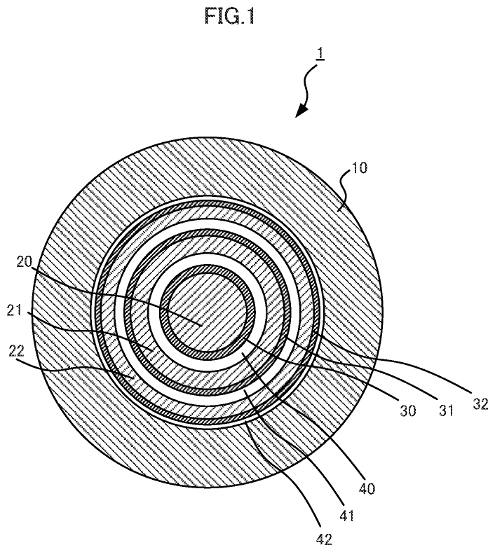

FIG. 1 is a cross-sectional view of a noise filter according to Embodiment 1 of the present disclosure. Symmetrical polyphase alternating current or round-trip current of direct current flows through a noise filter 1 according to Embodiment 1. The round-trip current is current that flows under direct current electric potential between a positive pole and a negative pole. The noise filter 1 includes a center conductor 20, at least one outer conductor having an interior through which the center conductor 20 is inserted, and a core 10 having an interior through which the center conductor 20 and the at least one outer conductor are inserted. The outer conductor is cylindrical in shape and the core 10 is a cylindrical magnetic body. The quantity of outer conductors is any value greater than or equal to 1. The center conductor 20 and the at least one outer conductor are insulated from each other. The phase currents of the symmetrical polyphase alternating current or the round-trip current of direct current flows through the center conductor 20 and the at least one outer conductor. On the outer peripheral side of the outer conductor in the outermost position in a steady state in which high-frequency noise current is not flowing, the magnetic fields that are produced by the phase currents are at least partially cancelled out. As a result, the core 10, in a steady state, concentrates the magnetic field produced by the phase currents, and thus magnetic saturation in the core 10 can be suppressed and noise removal efficiency can be improved.

FIG. 1 is a cross-sectional view of a cross section perpendicular to a central axis of the core 10. In the example of FIG. 1, the noise filter 1 includes, as outer conductors, a first outer conductor 21 and a second outer conductor 22. The center conductor 20, the first outer conductor 21, and the second outer conductor 22 are inserted through the interior of the core 10. The first outer conductor 21 and the second outer conductor 22 both have a cylindrical shape. The center conductor 20 is inserted through the interior of the first outer conductor 21. The first outer conductor 21, with the center conductor 20 inserted through the interior of the first outer conductor 21, is inserted through the interior of the second outer conductor 22. Three-phase alternating current flows through the noise filter 1. Phase currents of the three-phase alternating current flow through the center conductor 20, the first outer conductor 21, and the second outer conductor 22 in a direction of the central axis of the core 10. The size of the cross-section of the center conductor 20 is limited such that the shape of the center conductor 20 extends in a single direction. In the example of FIG. 1, the center conductor 20 is a rod-shaped conductor whose interior is filled. The shape of the center conductor 20 is not limited to the example of FIG. 1. For example, the center conductor 20 may be cylindrical in shape and have a hollow center similar to that of the first outer conductor 21 and the second outer conductor 22.

The outer peripheral surface of the center conductor 20 is covered with an insulating member 30. The outer peripheral surface of the first outer conductor 21 is covered with an insulating member 31. The outer peripheral surface of the second outer conductor 22 is covered with an insulating member 32. The insulating members 30, 31, and 32 are, for example, heat-shrinkable tubing with insulation properties. A gap 40 is provided between the outer peripheral surface of the insulating member 30 and the inner peripheral surface of the first outer conductor 21. A gap 41 is provided between the outer peripheral surface of the insulating member 31 and the inner peripheral surface of the second outer conductor 22. Also, a gap 42 is provided between the outer peripheral surface of the insulating member 32 and the inner peripheral surface of the core 10. The providing of the insulating members 30, 31, and 32 is unnecessary as long as the center conductor 20, the first outer conductor 21, and the second outer conductor 22 are insulated from one another by the gaps 40, 41, and 42.

A centroid of the cross-section of the center conductor 20 perpendicular to the central axis of the core 10 and a centroid of the cross section of each of the at least one outer conductor perpendicular to the central axis can be treated as being the same by setting the distance between the centroid of the cross section of the center conductor 20 and the centroid of the cross section of the at least one outer conductor to a sufficiently small value. In the steady state, the total sum of the phase currents is 0. Since the centroid of the cross section of the center conductor 20 and the centroid of each of the at least one outer conductor can be treated as being the same, the magnetic fields produced by the phase currents, in the steady state, is canceled out on the outer peripheral side of the outer conductor in the outermost position. Since the magnetic fields are canceled out on the outer peripheral side of the outer conductor in the outermost position, the core 10, in the steady state, does not concentrate the magnetic field. Conversely, in a case, for example, in which common mode noise that is high-frequency noise current is produced, the core 10 concentrates the magnetic field produced by the common mode noise, and high frequency loss attenuates noise by converting the magnetic field into heat. According to the noise filter 1, the core 10, in the steady state, concentrates the magnetic field produced by the phase currents, and thus magnetic saturation in the core 10 can be suppressed and noise removal efficiency can be improved. The result of the noise filter 1 is similar in the case in which round-trip current flows.

In the example of FIG. 1, the centroid of the cross section of the center conductor 20 perpendicular to the central axis of the core 10, the centroid of the cross section of the first outer conductor 21 perpendicular to the central axis, and the centroid of the cross section of the second outer conductor 22 perpendicular to the central axis can be treated as being coincident with one another. On the outer peripheral side of the second outer conductor 22, in the steady state, the magnetic fields produced by phase currents of the center conductor 20, the first outer conductor 21, and the second outer conductor 22 cancel out one another.

Moreover, the centroid of the cross section of the center conductor 20 perpendicular to the central axis of the core 10 and the centroid of the cross section of the core 10 perpendicular to the central axis can be treated as being the same by setting the distance between the centroid of the cross section of the center conductor 20 and the centroid of the cross section of the core 10 to a sufficiently small value. Also, as previously described, by setting the distance between the centroid of the cross section of the center conductor 20 and the centroid of the cross section of the at least one outer conductor to a sufficiently small value, the centroid of the cross section of the center conductor 20, the centroid of the cross section of the first outer conductor 21, and the centroid of the cross section of the second outer conductor 22, can be treated as being coincident with one another. With this configuration, noise removal efficiency improves when high-frequency noise flows through.

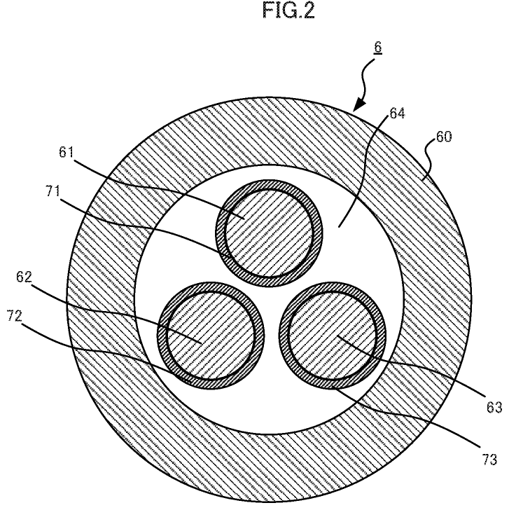

FIG. 2 is a cross-sectional view of a conventional noise filter. A noise filter 6 includes column-shaped conductors 61, 62, and 63 and a core 60 that is a cylindrical magnetic body. Each of the column-shaped conductors 61, 62, and 63 passes through the interior of the core 60. The outer peripheral surfaces of the column-shaped conductors 61, 62, and 63 are respectively covered with insulating members 71, 72, and 73. The centroids of the cross sections of the column-shaped conductors 61, 62, and 63 perpendicular to the central axis of the core 60 do not coincide with one another. Consequently, the core 60, in the steady state, concentrates the magnetic fields produced by the phase currents. As a result, magnetic saturation in the core 60 can occur.

In the noise filter 1 according to Embodiment 1, magnetic saturation in the core 10 is less likely to occur in comparison to that in the noise filter 6, and thus noise removal efficiency is high. Also, the interior of the core 60 in the configuration of the noise filter 6 has dead space 64 because the column-shaped conductors 61, 62, and 63 whose cross sections are circular are individually inserted through the interior of the core 60. The noise filter 1 according to Embodiment 1 does not have dead space on the interior of the core 10 as both the cylindrical outer conductors and the center conductor 20 are inserted through the interior of the core 10. In a case in which the surface area of the cross section perpendicular to the central axis of the core 10 and the surface area of the cross section perpendicular to the cross section perpendicular to the central axis of the core 60 are the same, the inner diameter of the core 10 is smaller than the inner diameter of the core 60. Also, the outer diameter of the core 10 is smaller than the outer diameter of the core 60. That is to say, the size of the cross section perpendicular to the central axis of the noise filter 1 is small compared to the cross section perpendicular to the central axis of the noise filter 6.

The cross-sectional surface area of the core 10 can be made larger than cross-sectional surface area of the core 60 by making the inner diameter of the core 10 smaller while also maintaining an outer diameter of the core 10 similar to the outer diameter of core 60. This greater cross-sectional surface area of the core 10 improves noise removal efficiency and suppresses a rise in temperature in the core 10. In the noise filter 6, the Mum-shaped conductors 61, 62, and 63 ought to be twisted in order to suppress magnetic field bias. Contrary to this, in the noise filter 1 according to Embodiment 1, twisting of the center conductor 20 and the outer conductors is unnecessary as the cylindrical outer conductors and the center conductor 20 are inserted through the interior of the core 10. Since bending work is unnecessary in the case of the noise filter 1, it is easy to pull components through in comparison to the noise filter 6 through which the twisted column-shaped conductors 61, 62, and 63 are inserted.

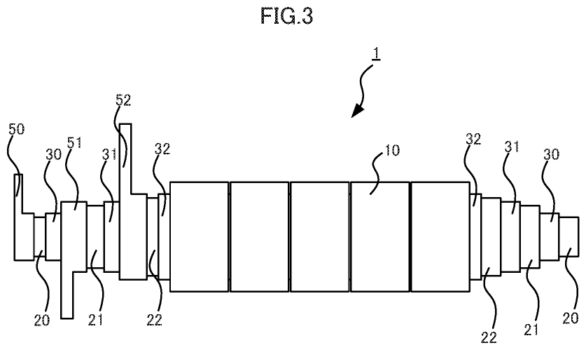

FIG. 3 is a side view of the noise filter according to Embodiment 1. Terminals 50 are attached to both ends of the center conductor 20. Terminals 51 are attached to both ends of the first outer conductor 21. Terminals 52 are attached to both ends of the second outer terminal 22. FIG. 3 illustrates only the terminals 50, 51, and 52 respectively provided on one end of the center conductor 20, the first outer conductor 21, and the second outer conductor 22. Description of the terminals 50, 51, and 52 provided on the other end is omitted. The terminals 50, 51, and 52 are crimp-on terminals, for example.

The length of the center conductor 20 in the longitudinal direction is longer than the length of each of the at least one outer conductor in the longitudinal direction. The longitudinal direction is the direction in which the current flows. In the example of FIG. 3, the length of the center conductor 20 in the longitudinal direction is longer than the length of the first outer conductor 21 and the length of the second outer conductor 22 in the longitudinal direction. In a case in which the noise filter 1 includes more than one outer conductor, the shorter the distance between the center conductor 20 and the outer conductor in a plane perpendicular to the central axis of the core 10, the longer the length of the outer conductor in the longitudinal direction. In the example of FIG. 3, the distance between the first outer conductor 21 and the center conductor 20 is shorter than the distance between the second outer conductor 22 and the center conductor 20. Therefore, the length of the first outer conductor 21 in the longitudinal direction is longer than the length of the second outer conductor 22 in the longitudinal direction. In other words, in the example of FIG. 3, the closer the conductor is to the central axis of the core 10, the longer the length of the conductor in the longitudinal direction.

After the center conductor 20, the first outer conductor 21, and the second outer conductor 22 are inserted through the interior of the core 10, the terminals 50, 51, and 52 may be respectively crimped-on. In such a case, the inner diameter of the core 10 may be made smaller because passing of the terminals 50, 51, and 52 through the interior of the core 10 is unnecessary. In other words, the inner diameter of the core 10 can be made smaller because the terminals are provided on the outer portion of the core 10. As the inner diameter of the core 10 can be made smaller in the aforementioned manner, the outer diameter of the core 10 can be made smaller, and thus the noise filter 1 can be made more compact. Moreover, by making the inner diameter of the core 10 smaller, noise removal efficiency can be improved. Also, the conductors 20, 21, and 22 may be bended and the bended portions may respectively serve as the terminals 50, 51, and 52.

In the example of FIG. 3, the noise filter 1 includes a plurality of cores 10 arranged in the direction of the central axis. By improving noise removal efficiency of the core 10 in the aforementioned manner, the quantity of the cores 10 included in the noise filter 1 can be reduced. In doing so, the noise filter 1 can be made more compact in the longitudinal direction, and thus the noise filter 1 can be installed even in locations where length restrictions apply.

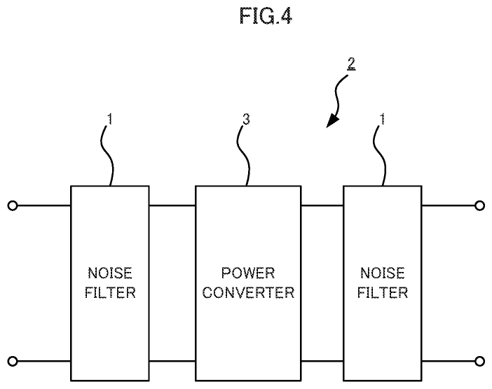

FIG. 4 is a block diagram illustrating an example configuration of a power conversion apparatus according to Embodiment 1. A power conversion apparatus 2 includes a power converter 3 that converts inputted power and outputs the converted power and a noise filter 1 provided on at least one of an input side or output side of the power converter 3. In the example of FIG. 4, although the noise filter 1 is provided on the input side and the output side of the power conversion 3, the noise filter 1 may be provided on only the input side or the output side. The power converter 3 may include a switching element made of a wide bandgap semiconductor having a wider bandgap than that of silicon. The wide bandgap semiconductor is, for example, silicon carbide, a gallium nitride-based material, diamond, or the like. When a switching element made of a wide bandgap semiconductor is used, the switching speed is faster, and thus switching noise increases. By providing the noise filter 1 according to Embodiment 1, noise produced by the power converter 3 that utilizes the switching element made of the wide bandgap semiconductor can be sufficiently removed.

As described above, the noise filter 1 according to Embodiment 1 of the present disclosure includes the at least one cylindrical outer conductor inserted through the interior of the cylindrical core 10 and the center conductor 20 inserted through the interior of the at least one outer conductor, thereby enabling the noise filter 1 to improve noise removal efficiency.

### Embodiment 2

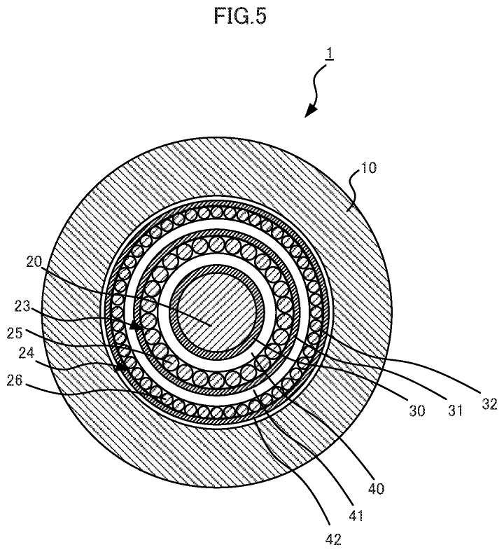

FIG. 5 is a cross-sectional view of a noise filter according to Embodiment 2 of the present disclosure. In the noise filter 1 according to Embodiment 2, at least one of the center conductor 20 or the outer conductor is a braided wire conductor having a plurality of braided conducting wires. In the example of FIG. 5, the noise filter 1 according to Embodiment 2 includes, as the outer conductors, a first outer conductor 23 and a second outer conductor 24. The first outer conductor 23 is a braided wire conductor having a plurality of braided conducting wires 25. Also, the second outer conductor 24 is a braided wire conductor having a plurality of braided conducting wires 26. The center conductor 20 may be a braided wire conductor having a plurality of braided conductors. In a case in which a braided wire conductor is used, a manufacturing process in which the fixing together cylindrical conductors as is the case for cylindrical conductors is unnecessary. Therefore, the manufacturing cost can be reduced.

There is an amplitude of steady-state current flowing (individually) through the center 20, the first outer conductor 23, and the second outer conductor 24 that is greater than or equal to a threshold. The threshold is, for example, greater than or equal to 10 A. Since current greater than or equal to 10 A flows through, the noise filter 1 can be used for noise removal in a main circuit.

The surface area of a cross section of the center conductor 20 perpendicular to the central axis of the core 10 and the surface area of the at least one outer conductor perpendicular to the central axis may be the same or may be different. By assigning the same value to the surface area of the cross section of the center conductor 20 and the surface area of the cross section of the outer conductor, the current density in the center conductor 20 and the current density in the outer conductor can be made the same.

As described above, the noise filter 1 according to Embodiment 2 of the present disclosure includes the at least one cylindrical outer conductor that is inserted through the interior of the cylindrical core 10 and the center conductor 20 that is inserted through the interior of the at least one outer conductor, thereby enabling improvement to noise removal efficiency. Moreover, by making at least one of the center conductor 20 or the outer conductor a braided wire conductor having a plurality of braided conducting wires, the manufacturing cost can be reduced.

The present disclosure is not limited to the above embodiments. The shape of the cross-sections of the center conductor 20, the at least one outer conductor, and the core 10 that are perpendicular to the central axis of the core 10 is not limited to the examples described above. The shape may be polygonal.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1, 6 Noise filter
2 Power conversion apparatus
3 Power converter
10, 60 Core
20 Center conductor
21, 23 First outer conductor
22, 24 Second outer conductor
25, 26 Conducting wires
30, 31, 32, 71, 72, 73 Insulating member
40, 41, 42 Gap
50, 51, 52 Terminal
61, 62, 63 Column-shaped conductor
64 Dead space

1. A noise filter comprising:
a center conductor;
a plurality of outer conductors, each being cylindrical in shape and having an interior through which the center conductor is inserted; and
a core that is a cylindrical magnetic body and has an interior through which the center conductor and the outer conductors are inserted,
wherein
the center conductor and the outer conductors are insulated from one another, and phase currents of symmetrical polyphase alternating current flow through the center conductor and the outer conductors.

2. A noise filter comprising:
a center conductor;
a plurality of outer conductors, each being cylindrical in shape and having an interior through which the center conductor is inserted; and
a core that is a cylindrical magnetic body and has an interior through which the center conductor and the outer conductors are inserted,
wherein
the center conductor and the outer conductors are insulated from one another, and
round-trip current of direct current flows through the center conductor and the outer conductors.

3. The noise filter according to claim 1, wherein a centroid of a cross section of the center conductor perpendicular to a central axis of the core and a centroid of a cross section of the outer conductors perpendicular to the central axis are treatable as being coincident with each other.

4-13. (canceled)

14. The noise filter according to claim 2, wherein a centroid of a cross section of the center conductor perpendicular to a central axis of the core and a centroid of a cross section of the outer conductors perpendicular to the central axis are treatable as being coincident with each other.

15. The noise filter according to claim 3, wherein the centroid of the cross section of the center conductor perpendicular to the central axis and a centroid of a cross section of the core perpendicular to the central axis are treatable as being coincident with each other.

16. The noise filter according to claim 14, wherein the centroid of the cross section of the center conductor perpendicular to the central axis and a centroid of a cross section of the core perpendicular to the central axis are treatable as being coincident with each other.

17. The noise filter according to claim 1, wherein
the noise filter includes, as the outer conductors, a first outer conductor having an interior through which the center conductor is inserted, and a second outer conductor having an interior through which the first outer conductor is inserted, and
current of each phase of three-phase alternating current flows through the center conductor, the first outer conductor, and the second outer conductor.

18. The noise filter according to claim 2, wherein
the noise filter includes, as the outer conductors, a first outer conductor having an interior through which the center conductor is inserted, and a second outer conductor having an interior through which the first outer conductor is inserted, and
current of each phase of three-phase alternating current flows through the center conductor, the first outer conductor, and the second outer conductor.

19. The noise filter according to claim 1, wherein at least one of the outer conductors is a braided wire conductor having a plurality of braided conducting wires.

20. The noise filter according to claim 2, wherein at least one of the outer conductors is a braided wire conductor having a plurality of braided conducting wires.

21. The noise filter according to claim 1, wherein an amplitude of steady-state current flowing through the center conductor and the outer conductors is greater than or equal to a threshold.

22. The noise filter according to claim 2, wherein an amplitude of steady-state current flowing through the center conductor and the outer conductors is greater than or equal to a threshold.

23. The noise filter according to claim 1, wherein a surface area of a cross section of the center conductor perpendicular to a central axis of the core and a surface area of a cross section of each of the outer conductors perpendicular to the central axis are treatable as being the same.

24. The noise filter according to claim 2, wherein a surface area of a cross section of the center conductor perpendicular to a central axis of the core and a surface area of a cross section of each of the outer conductors perpendicular to the central axis are treatable as being the same.

25. The noise filter according to claim 1, wherein a length of the center conductor in a longitudinal direction is longer than a length of each of the outer conductors in a longitudinal direction.

26. The noise filter according to claim 2, wherein a length of the center conductor in a longitudinal direction is longer than a length of each of the outer conductors in a longitudinal direction.

27. The noise filter according to claim 1, wherein
the shorter the distance between the center conductor and the outer conductor in a plane perpendicular to a central axis of the core, the longer the length of the outer conductor in a longitudinal direction.

28. The noise filter according to claim 2, wherein
the shorter the distance between the center conductor and the outer conductor in a plane perpendicular to a central axis of the core, the longer the length of the outer conductor in a longitudinal direction.

29. A power conversion apparatus comprising:
a power converter to convert inputted power and output the converted power; and the noise filter according to claim 1 provided on at least one of an input side or an output side of the power converter.

30. The power conversion apparatus according to claim 29, wherein the power converter includes a switching element made of a wide bandgap semiconductor using silicon carbide, a gallium nitride-based material, or diamond.
